(19) United States
(12) Patent Application Publication
(10) Pub. No.: US 2004/0076085 A1
(43) Pub. Date: Apr. 22, 2004

(54) Data library with robotically retrievable filter cartridge

(76) Inventors: Scott R. Patterson, Manitou Springs, CO (US); Merion D. White, Colorado Springs, CO (US)

Correspondence Address: Oppenheimer Wolff & Donnelly LLP, Suite 3300, 45 South Seventh Street, Minneapolis, MN, 55402-1609, US

(21) Appl. No.: 10/274,559

(22) Filed: Oct. 21, 2002

(51) Int. Cl. G11B 7/085; G11B 21/08; G11B 15/68; G11B 3/70; G11B 5/84; G11B 7/26

(52) U.S. Cl. 369/30.4; 360/92; 369/291

(57) ABSTRACT

A data library supporting a plurality of data cartridges, at least one filter cartridge, and a picker/placer mechanism that is capable of manipulating both types of cartridges. The filter cartridge prevents airborne particulates from contaminating the data library. The cartridge design allows the picker/placer to be used to insert or remove a filter for cleaning or replacement, thereby obviating the need for shutting down the library for filter maintenance.

### BACKGROUND OF THE INVENTION

The device of the present invention relates to an air filtering system for a data storage device. More specifically, the invention relates to a system for controlling dust and contamination within a robotically operated data storage library.

As is easily appreciated by most members of today's society, information and data affect virtually all aspects of life. Computer systems are used to manage and use this data for all types of different reasons. Naturally, the storage and retrieval of data is a critical part of making these systems work.

It is well understood that data storage can be accomplished using several mechanisms, including hard drives, tape media, optical disks, magnetic media, removable storage cards, etc. Since the launch in 1982 of the audio CD, optical disks have become a very popular storage media due to their durability, random access features, and the high capacities that can be achieved on a single removable disk. The computerization of businesses has steadily increased the amount of data that is processed. As more data is processed, the amount of data which must be stored increases as well. To meet the need of this ever increasing amount of data, cost-effective data storage is desired. To remain competitive and to meet the needs for storage, increasing the disk capacity is a paramount development goal for optical drive products. (See, P. Asthana, B. I. Finkelstein, and A. A. Fennema, “Rewritable optical disk drive technology,” IBM Journal of Research and Development, Vol. 40, No. 5 (1996))

As disks are engineered to provide greater capacity, dust and other contaminants are more problematic. One method of increasing an optical disk's capacity is by using a stronger object lens, which must be placed closer to the optical media. Dust becomes a more pressing problem in these situations because a dust particle now interferes with a greater portion of the focused laser beam. If enough of the laser beam is obstructed, data may be inaccessible. Thus, while optical disks were once lauded for their durability and ability to resist small amounts of contaminates, the super capacity drives now on the market are less resistant to the deleterious effects of contamination. As a result, contamination must either be prevented from reaching the disk or cleaning of the disk is required once it is contaminated.

There have been various attempts to deal with disk contamination. One common method has been to package the disk within a disk cartridge. Disk cartridges include a door assembly which is opened by the disk drive so that the disk within the cartridge can be accessed. Of course, as soon as the door assembly is opened, the disk is exposed to airborne dust. Thus, additional measures are desired to ensure that the surrounding atmosphere is free of dust when the disk door is open.

One solution to the aforementioned need for increased data storage is the data storage library. Understandably, data storage libraries have become increasingly complex as the demand for storage capacity increases. Storage libraries are traditionally designed to accommodate large organizations and include mechanized picker/placers used to retrieve disk cartridges automatically as they are summoned by a computer system. The cartridges are then transported to an open storage drive so they can be easily read or written to. In order to maintain the maximum efficiency of the optical storage devices used, and to avoid the problems outlined above, these libraries must be kept free from dust and other airborne contaminants. Air quality controls will help to minimize mechanical problems and avoid comprising the data stored on the disks.

In order to maintain a high level of air quality, some existing libraries are equipped with air filtration systems. These filtration systems include ducts to direct air flow, fans, and filter elements. Like all filtration systems, the filters must be periodically removed and cleaned. This becomes problematic in highly used data storage libraries because the library must be temporarily shut down while it is manually opened in order to access the filters. This can disrupt operation of the data storage system and cause undesired delays. Further, the periodic opening and closing of the library cabinet exposes the interior to additional levels of dust.

One approach to the problems created by opening the library cabinet or shutting the library down, is to utilize an external filter along with an internal fan to draw air into the cabinet through the filter. However, this solution presents certain problems. First, after the filter is removed, a relatively large passageway directly to the interior of the library remains through which a significant amount of airborne contaminates are allowed to pass. If the library remains operational, and the fan remains on, this problem is exacerbated by increased airflow. Second, it is foreseeable that the filter may get jostled during removal, causing a build up of dust to become agitated and dislodged from the filter into the air, thus potentially emitting a cloud of dust into the cabinet interior. Third, outside filters do not lend themselves to automated management systems without some form of human interaction. Though a timer can be implemented that reminds a user to change the filter, the user is still required to manually change the filter and reset the timer. Fourth, the level of desired cleanliness inside a data library calls for a filter capable of filtering fine particles. Filters having a low enough micron rating to accomplish such filtering would get clogged quickly if mounted on the outside of the library cabinet.

There is thus a need for a filtration system for a data storage library which can be maintained without shutting down the operation of the library. Such a system can be managed by the library controller to insure the most optimum operating conditions.

There is also a need for a system that can control dust within a library while minimizing exposure to the outside atmosphere;

There is a further need for a filtration system that can be tracked and maintained automatically. Such a system must also be capable of easy incorporation into a data storage library.

### BRIEF SUMMARY OF THE INVENTION

The present invention addresses the aforementioned needs by providing a filtering system which utilizes a transportable filter cartridge designed for a data library. The cartridge includes several of the external features and dimensions that are found on the media cartridges used in the library. These similar features allow the robotic arm, or picker/placer mechanism of the library to be used to change the filters when replacement or cleaning is necessary. This design obviates a need for the library to be shut down and opened in order to replace or clean filters.

The present invention also manages air flow into the cabinet of a library system to control the interior environment. This includes the controlled operation of fans and necessary ducts to direct air in a desired manner. In order to control dust, mechanisms are required to direct air through a filter element which is contained in the filter cartridge.

One aspect of the present invention is a filter cartridge which includes a shutter door that covers the filter portion or element. The shutter door opens as the cartridge is placed in the operative filter slot of the data library, thereby allowing air to flow through the filter. However, when the filter cartridge is removed for cleaning or replacement, the shutter door closes, thereby preventing dirt trapped by the filter from contaminating the data library.

Another aspect of the present invention is a system or mechanism for preventing the insertion of the filter cartridge into a media drive and for preventing the insertion of a media cartridge into an operative filter cartridge slot within the library. The operative filter cartridge slot is configured to appropriately position the filter cartridge in the ducting so that air is directed through the filter element. The need for misinsertion mechanisms is obvious considering the drastic differences between the cartridges involved (i.e., filter cartridge and data cartridge). Preferably this misinsertion mechanism is a keying feature that includes a physical attribute of the cartridge housing that corresponds with a physical attribute of the appropriate slot. Importantly, the attribute of the filter cartridge housing does not interfere with the ability of the picker/placer mechanism to insert and remove the filter cartridge housing. Alternatively, this could include a marking device, readable by the picker/placer mechanism, that identifies the filter cartridge and prevents the picker/placer mechanism from placing the filter cartridge in a media drive. Additionally, the picker/placer mechanism is constructed and arranged to require the presence of such a marking on a cartridge before it places the cartridge in a filter cartridge slot. This also prevents the picker/placer mechanism from placing the media cartridge in a filter cartridge slot.

Another aspect of the cartridge is a marking system that facilitates an ability of the data library to maintain an inventory of the filter cartridges. The inventory preferably includes a time tracking feature that allows the library to maintain a history on the duration of service of each filter cartridge, so that replacement and cleaning may be scheduled accordingly. Further, filter cartridges can be automatically changed/replaced by the control systems within the library.

### BRIEF DESCRIPTION OF THE DRAWINGS

FIG. 1 is a perspective view of a data cartridge of the prior art;

FIG. 2 is a perspective view of a data library of the present invention;

FIG. 3 is a perspective view of a filter cartridge of the present invention; and,

FIG. 4 is a plan view of a preferred bin embodiment of the present invention.

### DETAILED DESCRIPTION OF THE INVENTION

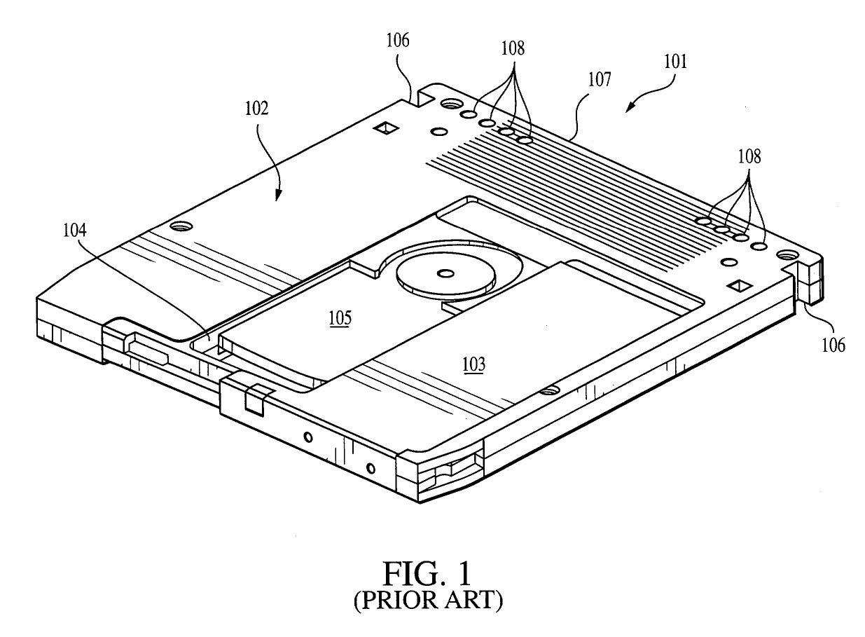

An example of a data cartridge 101 is shown in FIG. 1. Data cartridge 101 includes a housing 102 and a slideable, spring loaded shutter door 103 that, when opened, uncovers an access window 104 to a computer readable disk 105. The housing 102, in addition to defining the window 104, includes notches 106 for allowing a picker/placer mechanism to grab and manipulate the data cartridge 101. In FIG. 1, this includes a pair of opposed notches 106 near the outer edge 107 of the data cartridge 101, but may be any suitable notch, ridge, protuberance, indentation, or the like. The housing also includes a plurality of flag holes 108 near the outer edge 107. These flag holes 108 are detectable by the library slot into which the data cartridge 101 is placed, by the picker/placer that is used to manipulate the data cartridge 101, or both. Various meanings may be associated with these flag holes 108 such as, write protected, head cleaning disk, maximum memory capacities, or any important characteristic of the cartridge that should be identified by either the slot or the picker/placer mechanism. Alternatively, these flag holes may interact with structures within the media drive in order to accommodate operation.

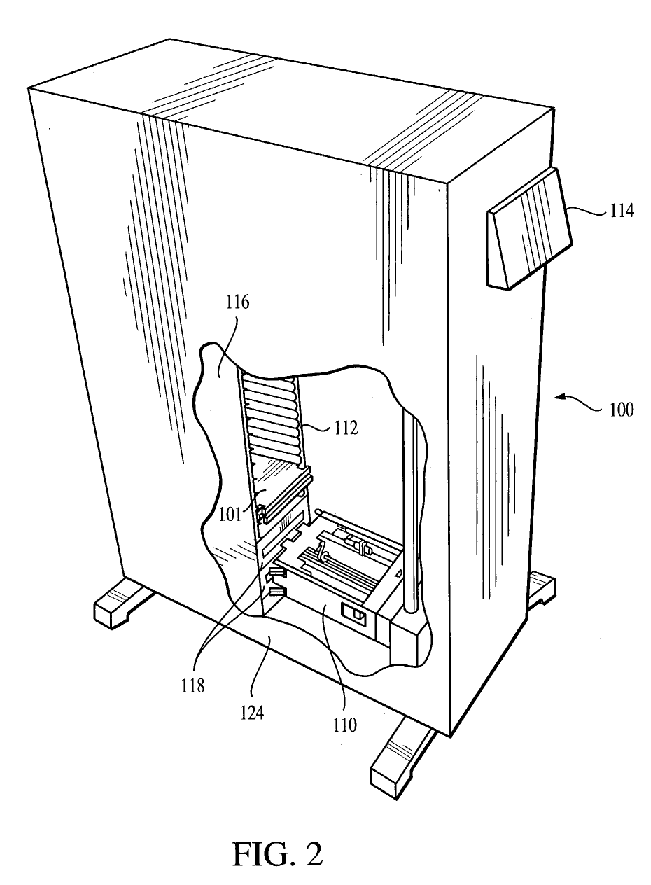

FIG. 2 shows an example of a data library 100, in which the data cartridge 101 may be used and stored. The library 100 includes a picker/placer 110 that is positionable for accessing data cartridges 101. At least two cartridge grippers 124 allow the picker/placer 110 to grab and manipulate the data cartridges 101. More specifically, the grippers 124 allow the picker/placer 110 to remove or insert data cartridges 101 from or to the plurality of data cartridge slots 112 formed in a column 116 of the library 100. A library 100 may have more than one column 116 of slots. An access door 114, allows an operator to introduce cartridges to the library or remove them therefrom. A similar data library 100 is described in detail in U.S. Pat. No. 5,602,821, incorporated by reference herein in its entirety.

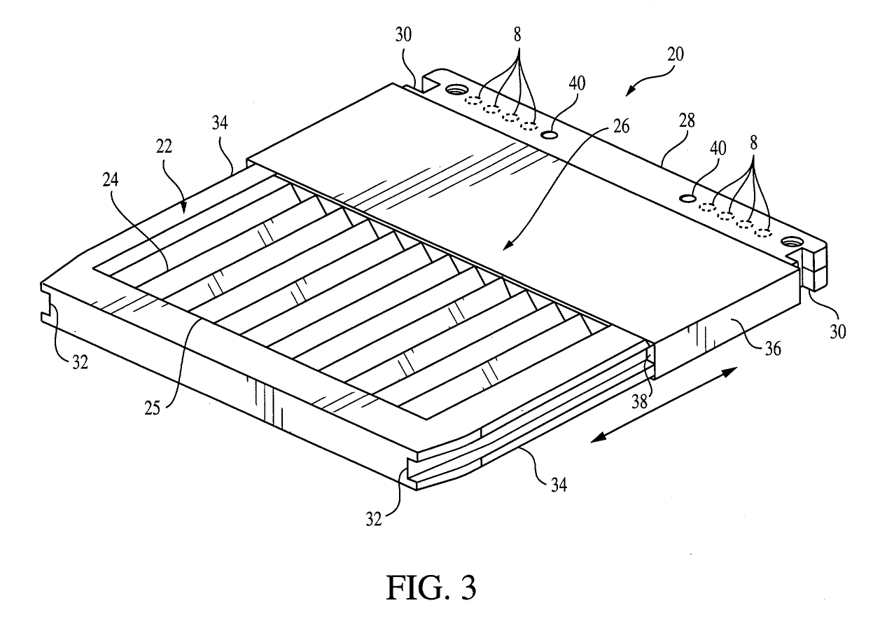

Referring now to FIG. 3, there is shown a preferred filter cartridge 20 of the present invention. Filter cartridge 20 generally includes a housing 22, a filter 24 contained within a window 25 defined by the housing 22, and, preferably a shutter door 26. The housing 22 is constructed and arranged to be similar to the housing 22 of data cartridge 101, shown in FIG. 1. Most importantly, the housing 22 includes an outer edge 28 and a notch 30 for allowing a picker/placer mechanism 110 to grab and manipulate filter cartridge 20. The notches 30 of the preferred embodiment shown in FIG. 3 is a pair of opposed notches 30, but may be suited, as explained above, to the particular picker/placer mechanism 110 used by the library 100. Thus, for purposes of the present invention, the specific mechanism for allowing a picker/placer mechanism 110 to grab and manipulate filter cartridge 20 is only important to the extent that a given picker/placer 110 may be used to grab and manipulate both the data cartridges 101 and the filter cartridges 20, used in a particular data library 100.

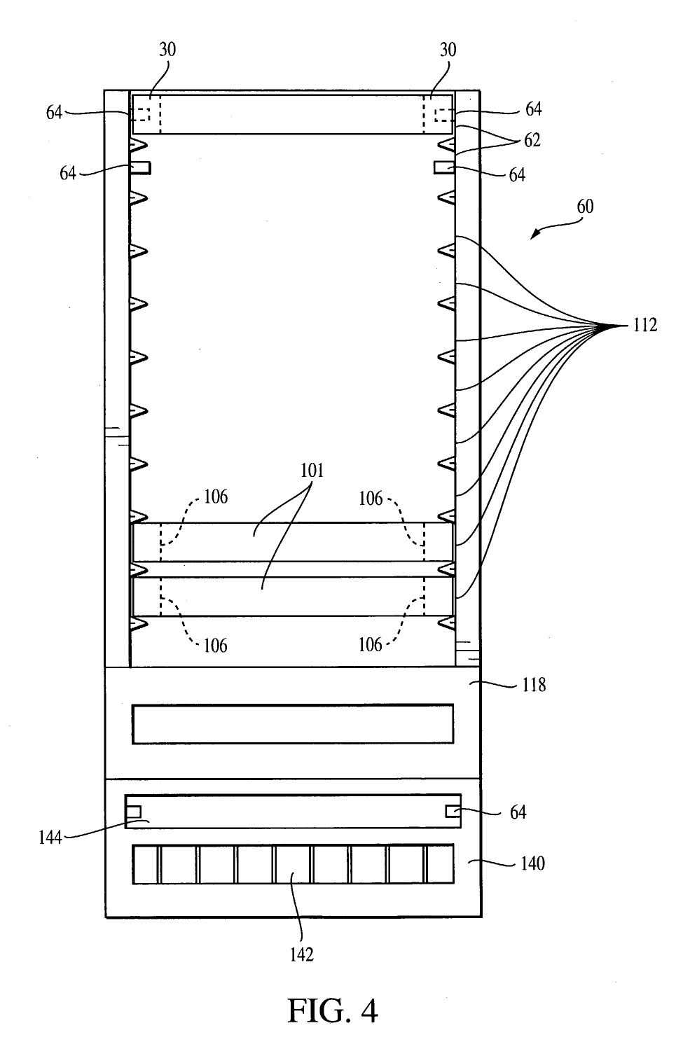

As introduced above, preferably, the filter cartridge 20 also includes a mechanism to cover the filter 24 whenever the filter cartridge 20 is not installed in an operative filter slot 42 (see, FIG. 4, discussed below) of the library 100. The shutter door 26 is a preferred mechanism and is shown in FIG. 3 in the open position, whereby the filter 24 is exposed. The shutter door 26 is moveable, and preferably spring biased towards a closed position (not shown) whereby the filter 24 is covered.

Notably, the shutter door 26 of the filter cartridge 20 moves in a direction that is perpendicular to the outer edge 28 of the filter cartridge 20, whereas the shutter door 103 of the data cartridge 101 moves in a direction that is parallel to the outer edge 7 of the data cartridge 101. The filter cartridge 20 is constructed and arranged to maximize the size of the filter 24 that is usable when the filter cartridge 20 is inserted into an operative filter slot 42 in the library 100. A bigger filter 24 provides less resistance to air flow and can collect a greater quantity of contaminants before it needs to be replaced. Providing a shutter door 26 that opens by moving toward the outside edge 28 of the filter cartridge 20 to expose the filter 24, permits a greater exposed filter area. Conversely, the necessary exposed portion of the disk 105 that spins within the data cartridge 101 is relatively small and necessarily radial. Thus, in a data cartridge 101 a thin window 104 that extends to the center of the disk 105, is optimal. Such a window 104 is only as large as necessary, thus minimizing the exposure of the disk 105 to potential contaminants.

The design of filter cartridge shutter door 26 also provides a mechanism for preventing the accidental insertion of a data cartridge 20 into a operative filter slot 42. The cartridge housing 22 defines a groove 32 on either side 34 of the filter cartridge 20. The shutter door 26 includes a pair of overhangs 36 that extend over the sides 34 of the filter cartridge 20. The overhangs 36 each include a tab 38 that travels within the groove 32.

Referring to FIGS. 3 and 4, the groove 32/tab 38 arrangement serves multiple functions. The arrangement controls the travel of the shutter door 26 and holds the shutter door 26 onto the housing 102. FIG. 4 shows a preferred storage bin 60 of the present invention. Storage bin 60, in addition to having data cartridge slots 112 and data cartridge drives 118, has filter cartridge slots 62. The filter cartridge slots 62 differ from the data cartridge slots 112 due to a tongue 64. The tongues 64 interact with grooves 32 of housing 22 to allow only filter cartridges to be placed therein. The initial portion of groove 32 will surround tongue 64 when filter cartridge 20 is inserted into filter cartridge slot 62. Shutter 26 is not opened however, when placed in these filter cartridge slots 62. The tongue 64 also prevents the insertion of a data cartridge 101, which does not have a side groove.

The existence and configuration of filter cartridge slots 62 allow only filter cartridge 20 to be housed therein. This provides a mechanical method of tracking the location of both filter cartridge 20 and data cartridges 101 within one library. It should be noted that the filter cartridges 20 could be stored in data cartridge slots 112, so long as their position is tracked. Thus, filter cartridge slots 62 may not be necessary as filter cartridges 20 would be tracked differently.

Also shown in FIG. 4 is a filtration system 140 which includes the necessary ducts to direct air from outside the cabinet, through filter 24, and into the cabinet via vent 142. Filtration system 140 also has an operative filter slot 144 configured to receive filter cartridge 20. As can be seen, this operative filter slot 144 includes tongues 64 to interact and appropriately open shutter door 26.

Additional measures may also be used to prevent the insertion of a data disk 101 into a filter slot 62 and vice versa. For example, a flag hole 40 may be used to alert the picker/placer 110 that the cartridge 20 is a filter cartridge 20. In FIG. 1, the positions of the flag holes 108 of the data cartridge 101 are shown in phantom lines to indicate that the flag hole 40 of the filter cartridge 20 is offset from the flag holes 108 of the data cartridge 101.

The flag hole 40 may also be used as a tracking and maintenance tool. Again, when the picker/placer 110 detects the flag hole 40, the picker/placer controller, usually a computer (not shown), ensures that the data cartridge 101 is not placed in a filter slot 62 or operative filter slot 144 of the library 100. Additionally, the computer controlling the picker/placer, makes a data entry as to the time of placement and the library slot address into which the filter cartridge 20 was placed. Thus, the computer is able to maintain a log of how long each filter cartridge 20 has been in service without replacement or cleaning. Thus, the flag hole 40 may be used to trigger a maintenance schedule.

Alternatively, another flag, such as a bar code (not shown), or the like may be used to effect preventing a misplaced cartridge and maintenance scheduling. Preferably, for purposes of preventing a misplaced cartridge, however, the flag is detectable by the picker/placer 110.

In one embodiment, shown in FIG. 3, the housing 102 is symmetric such that the filter cartridge 20 may be placed in a filter slot 62 of the library 100 in two orientations, so long as the outside edge 28 remains at least partially outside the slot 62. This feature prevents time consuming loading errors.

In a second embodiment, not shown, the housing 102 is asymmetric such that the filter cartridge 20 may be loaded in only one orientation into a filter slot 62 of the library 100. This prevents the reintroduction of residual dirt, still present after an ineffective filter cleaning attempt, into the library 100, such as would be the case if this dirt was placed on the leeward side of the filter 24 when the ineffectively cleaned filter 24 is placed back into the library 100.

While the preferred embodiment shown in the Figures above illustrate the use of a data cartridge 101 containing a disk 105, it us understood that the present invention is adaptable to other types of libraries. For example, a library that makes use of a data cartridge that houses storage tape could also utilize appropriately configured filter cartridges, Further, a library that utilizes raw media (e.g. CD's or DVD's) could also include appropriately configured filter cartridges that are transportable by the picker/placer mechanism.

In another aspect of the present invention, controls are put in place to insure that the cabinet interior is never exposed to the outside environment. According to this feature of the present invention, a damper is provided in the air flow ductwork to block air flow at appropriate time. This damper would be opened when a filter cartridge is mounted in a appropriate position. This is accomplished by having the cartridge interact with a damper switch. Alternatively, the library controller can coordinate the operation of the damper when filter cartridges are changed. Further, control of the fan can also be included to create a comprehensive air flow control system.

It is contemplated that features disclosed in this application can be mixed and matched to suit particular circumstances. Various other modifications and changes will be apparent to those of ordinary skill in the art without departing from the spirit and scope of the present invention. Accordingly, reference should be made to the claims to determine the scope of the present invention.

What is claimed is:

1. A filter cartridge for a data library that uses a picker/placer to load and unload data cartridges, comprising:
a housing defining a window into which a filter may be operably contained, the housing including a outside edge constructed and arranged to be manipulated by a picker/placer of a data library;
a filter operably contained within said window.

2. The filter cartridge of claim 1, further comprising a shutter door operably attached to the housing and slideable between a closed position and an open position, whereby when said shutter door is in said closed position, said shutter door covers said filter.

3. The filter cartridge of claim 2 wherein said shutter door is proximate said outside edge in said open position and distal said outside edge in said closed position.

4. The filter cartridge of claim 1 further comprising a flag, operably attached to said housing, detectable by the picker/placer, identifying said filter cartridge as a filter cartridge.

5. The filter cartridge of claim 4 wherein said flag comprises a hole defined by said housing proximate said outside edge.

6. The filter cartridge of claim 4 wherein said flag comprises a bar code on said housing proximate said outside edge.

7. The filter cartridge of claim 2 wherein said housing is symmetric along at least one axis of symmetry.

8. The filter cartridge of claim 2 wherein said housing is asymmetric.

9. The filter cartridge of claim 1 wherein said housing comprises a side edge defining a groove constructed and arranged to slideably accept a tongue when said filter cartridge is inserted into a filter slot of the data library.

10. A data library comprising:
at least one bin;
a plurality of data cartridge slots defined by said at least one bin;
at least one operative filter cartridge slot defined by said at least one bin;
a picker/placer useable to insert and remove data cartridges to and from said data cartridge slots, and useable to insert and remove filter cartridges to and from said at least one operative filter cartridge slot.

11. The data library of claim 10 further comprising a filter cartridge, insertable into said filter cartridge slot, the filter cartridge having:
a housing defining a window into which a filter may be operably contained, the housing including a outside edge constructed and arranged to be manipulated by a picker/placer of a data library;
a filter operably contained within said window.

12. The data library of claim 11, the filter cartridge further having a shutter door operably attached to the housing and slideable between a closed position and an open position, whereby when said shutter door is in said closed position, said shutter door covers said filter.

13. The data library of claim 12 wherein said filter cartridge shutter door is proximate said outside edge in said open position and distal said outside edge in said closed position.

14. The data library of claim 11 the filter cartridge further having a flag, operably attached to said housing, detectable by the picker/placer, identifying said filter cartridge as a filter cartridge.

15. The data library of claim 14 wherein said flag comprises a hole defined by said housing proximate said outside edge.

16. The data library of claim 14 wherein said flag comprises a bar code on said housing proximate said outside edge.

17. The data library of claim 11 wherein said housing comprises a side edge defining a groove constructed and arranged to slideably accept a tongue when said filter cartridge is inserted into said operative filter cartridge slot of the data library.

18. The data library of claim 17 wherein said operative filter cartridge slot comprises an opening with said tongue protruding into said opening slot such that it engages said groove when said filter cartridge is inserted therein.

19. The data library of claim 12 wherein operative filter slot has a tongue that is slidingly accepted by a groove defined by a side edge of said housing, and wherein said shutter door is constructed and arranged to interfere with said tongue such that when said filter cartridge is inserted in said filter cartridge slot, said tongue contacts said shutter door, causing said shutter door to move from said closed position to said open position.

20. A data library comprising:
a first means for storing data in a computer-readable form;
a second means for storing said first means;
a third means for filtering air entering the data library; and,
a fourth means for manipulating said first means and said third means.

21. The data library of claim 20 wherein said third means comprises:
a housing defining a window into which a filter may be operably contained, the housing including a outside edge constructed and arranged to be manipulated by a picker/placer of a data library;
a filter operably contained within said window.

22. The data library of claim 21 wherein said third means further comprises a shutter door operably attached to the housing and slideable between a closed position and an open position, whereby when said shutter door is in said closed position, said shutter door covers said filter.

23. The data library of claim 20 further comprising a fifth means for distinguishing said third means from said first means.

24. The data library of claim 23 wherein said fifth means comprises a flag detectable by the fourth means, identifying said third means as a third means.

25. The data library of claim 23 wherein said fifth means comprises a flag detectable by the fourth means, identifying the first means as a first means.

26. A data storage library having a controlled interior environment, the data storage library comprising:
a plurality of storage bins for accommodating a plurality of storage media devices;
a media drive for reading the storage media device when placed therein;
a filter cartridge having a filter element therein;
a picker for the controlled moving of the storage media devices and the filter cartridge;
an air movement system having an inlet communicating with air outside the library, an outlet communicating with air in the library, ducts to direct air between the inlet and the outlet, and an operative filter slot in the duct configured to receive the filter cartridge such that air moving from the inlet to the outlet must pass through the filter.
